(19) United States
(12) Patent Application Publication
(10) Pub. No.: US 2022/0070379 A1
(43) Pub. Date: Mar. 3, 2022

(54) Optical Member Driving Device, Camera Device and Electronic Apparatus

(71) Applicant: New Shicoh Motor Co., LTD, Zhejiang (CN)

(72) Inventor: Tatsuki WADE, Yamato City (JP)

(21) Appl. No.: 17/462,728

(22) Filed: Aug. 31, 2021

(30) Foreign Application Priority Data
Sep. 3, 2020 (CN) 202010916822.X

(51) Int. Cl. H04N 5/232; H04N 5/225

(52) U.S. Cl. CPC H04N 5/23287; H04N 5/2254

(57) ABSTRACT

An optical member driving device is provided. The device includes an optical member with a lens body, a bottom board, a slider provided on a rear surface of the optical member and having a convex spherical surface, and a receiving portion provided on a front surface of the bottom board and receiving the slider at least at three points.

### CROSS-REFERENCE TO RELATED APPLICATION

This application claims the benefit of Chinese patent application CN202010916822.X, filed on Sep. 3, 2020, the contents of which are incorporated by reference herein.

### TECHNICAL FIELD

The present disclosure relates to an optical member driving device used in electronic apparatus such as smartphones, a camera device, and an electronic apparatus.

### BACKGROUND

Among camera devices used in electronic apparatus such as smartphones, there are some devices performing hand shake correction by tilting optical members that include lens bodies and image sensors around the X axis or the Y axis. As a document disclosing a technique related to this type of camera device, Japanese Patent Application Publication No. 2009-294393A (hereinafter referred to as “Patent Document 1”) can be given. In the optical device for photographing disclosed in this Patent Document 1, a pivot portion is provided at the center of the base, the center of the bottom surface of the optical member is supported by this pivot portion, a magnet for hand shake correction is provided on the outer surface of the optical member opposed to the X direction and the Y direction, and a coil for hand shake correction is provided on the inner surface of the fixed cover. In this device, when a current flows through the coil, the optical member tilts around a point supported by the pivot portion.

However, in the case of the technique of Patent Document 1, since the optical member tilts around the rear end portion supported by the pivot portion, there is a problem that the moving amount of the front end portion of the optical member in the XY direction increases and the size of the device becomes larger.

### SUMMARY

One of objects of the present disclosure is to provide an optical member driving device in which moving amount of the front end portion of the optical member is small and the size thereof can be reduced.

In accordance with a first aspect of the present disclosure, there is provided a lens driving device including: an optical member with a lens body; a bottom board; a slider which is provided on a rear surface of the optical member and has a convex spherical surface; and a receiving portion which is provided on a front surface of the bottom board and receives the slider at least at three points.

In accordance with a second aspect of the present disclosure, there is provided a camera device including the optical member driving device described above.

In accordance with a third aspect of the present disclosure, there is provided an electronic apparatus including the camera device described above.

### DESCRIPTION OF DRAWINGS

FIG. 1 is a front view of a smartphone on which a camera device is mounted, the camera device including an optical member driving device according to an embodiment of the present disclosure;

FIG. 2 is a perspective view of the optical member driving device of FIG. 1;

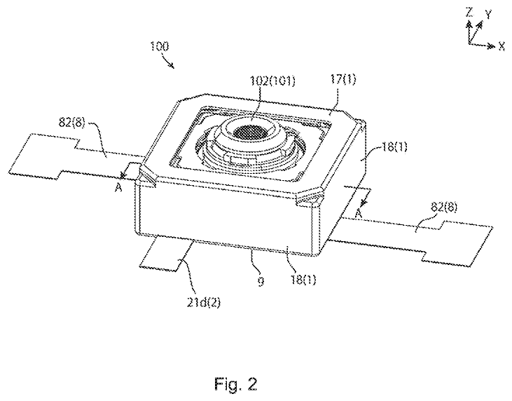

FIG. 3 is an exploded perspective view of the optical member driving device of FIG. 2;

FIG. 4 is a perspective view in which the cover, the camera module, the second FPC, and the bottom board are removed from FIG. 2;

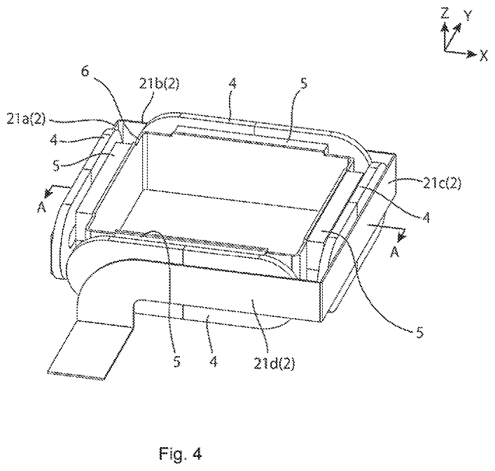

FIG. 5 is a cross-sectional view taken along line A-A of FIG. 2;

FIG. 6 is a diagram showing the second FPC of FIG. 2; and

FIG. 7 is a developed view of the second FPC of FIG. 6.

### DETAILED DESCRIPTION

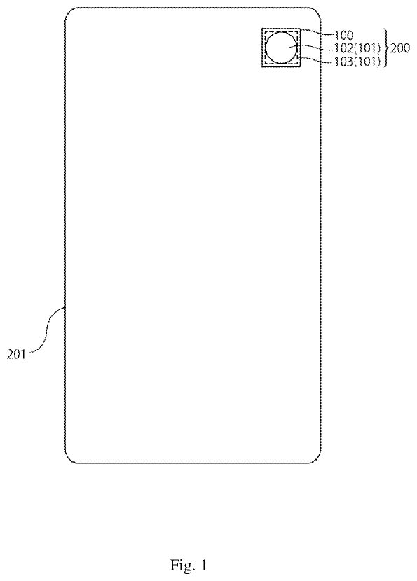

As shown in FIG. 1, a camera device 200 including an optical member driving device 100 according to one embodiment of the present disclosure is accommodated in a housing of a smartphone 201.

The camera device 200 includes a camera module 101 as the optical member, and an optical member driving device 100 that holds the camera module 101. The camera module 101 includes a lens body 102, an image sensor 103, a lens driving device 104, and a rectangular parallelepiped housing 105 covering them. The image sensor 103 converts the light incident via the lens body 102 into an image signal and outputs the image signal. The lens driving device 104 drives the lens body 102 along a direction parallel to the optical axis thereof, but it may be omitted.

Here, an XYZ orthogonal coordinate system is employed, and the X axis, the Y axis, and the Z axis are orthogonal to each other. The optical axis direction of the lens body 102 is in parallel to the Z direction in a non-operation state. Further, the side of the subject viewed from the lens body 102 is the +Z side, and may be referred to as the front side, and the opposite side (the image sensor 103 side) is the −Z side, and may be referred to as the rear side. Further, the surface facing the front side is referred to as the front surface, and the surface facing the rear side is referred to as the rear surface. Further, among the surfaces parallel to the Z axis, the surface facing the direction closer to the optical axis is referred to as the inner surface, and the surface facing the direction away from the optical axis is referred to as the outer surface.

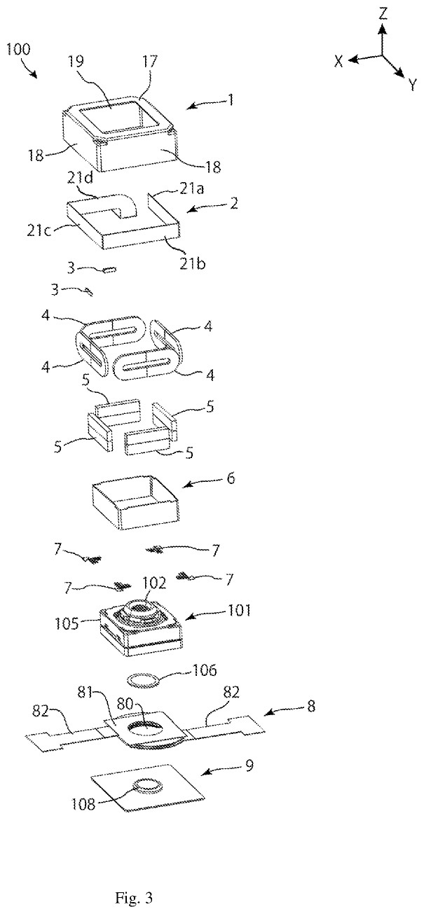

As shown in FIG. 3, the optical member driving device 100 has a cover 1, a first FPC 2, two Hall elements 3, four coils 4, four magnets 5, a frame 6, four leaf springs 7, a slider 106, a second FPC8, and a bottom board 9.

The cover 1 has a quadrangular front board 17, and four side boards 18 extending from four sides of the front board 17 to the −Z side. A quadrangular through hole 19 is provided in the front board 17 of the cover 1. The cover 1 and the quadrangular bottom board 9 are combined as an outer housing. The first FPC2, the Hall element 3, the coils 4, the magnets 5, the frame 6, the leaf springs 7, the camera module 101, the slider 106, and the second FPC8 are held in this outer housing. The camera module 101 is exposed from the through hole 19 of the cover 1 to the +Z side.

The frame 6 is a used to fix the camera module 101 inside thereof, and is a frame-shaped body configured by four walls extending in the Z direction. When the camera module 101 is installed, the four side surfaces of the housing 105 are surrounded by the frame 6 and fixed to the frame 6 via an adhesive. A magnet 5 is fixed to the outer surface of the frame 6 also as a driving portion for driving the camera module 101. The magnet 5 is configured by two rectangular parallelepiped magnet pieces arranged side by side in the Z direction. The two magnet pieces are magnetized in such a manner that the magnetic poles in the board surface direction are mutually reverse magnetic poles. For each magnet 5, one magnet piece may be arranged so as to be in the magnetic pole arrangement described above. Further, each magnet 5 may be directly fixed to the camera module 101 instead of the frame 6, and may also serve as a magnet for driving the lens in the camera module 101.

The first FPC 2 is provided inside the four side boards 18 of the cover 1. The first FPC2 has a first plate portion 21a, a second plate portion 21b, a third plate portion 21c, and a fourth plate portion 21d fixed to the side boards 18 on the −X side, the +Y side, the +X side, and the −Y side, respectively.

The first plate portion 21a and the second plate portion 21b, the second plate portion 21b and the third plate portion 21c, and the third plate portion 21c and the fourth plate portion 21d intersect at right angles and are connected to each other at the corner portion on the −X+Y side, the corner portion on the +X+Y side, and the corner portion on the +X−Y side. The end portion of the fourth plate portion 21d on the −X side is changed in orientation and extends to the rear side before reaching the corner portion on the −X-Y side of the cover 1.

The tip of the fourth plate portion 21d extending to the rear side is bent to the −Y side at a position of the rear edge of the side board 18 of the cover 1 on the −Y side, and projects to the −Y side from a gap between the cover 1 and the bottom board 9 formed by a notch of the side board 18. The tip end portion of the fourth plate portion 21d projecting to the −Y side is electrically connected to an external substrate.

Each coil 4 as a driving portion opposed to the magnet 5 is fixed to each inner surface of the first plate portion 21a, the second plate portion 21b, the third plate portion 21c, and the fourth plate portion 21d of the first FPC 2. The coils 4 fixed to the first plate portion 21a and the third plate portion 21c are wound around the X axis as a winding axis, and the coils 4 fixed to the second plate portion 21b and the fourth plate portion 21d are wound around the Y axis as a winding axis. The coils 4, together with the magnets 5, constitute a driving portion that tilts the camera module 101 around the axes in the X direction and the Y direction.

One Hall element 3 is arranged in each of the air-core portion of the coil 4 on the +X side and the air-core portion of the coil 4 on the −Y side. The Hall elements 3 are fixed to the inner surfaces of the third plate portion 21c and the fourth plate portion 21d. The Hall element 3 detects the magnetic field from the magnet 5 opposed to the Hall element 3, and outputs a signal indicating the detection result.

The leaf spring 7 has an outer portion attached to the cover 1, an inner portion attached to the frame 6, and an arm portion elastically connecting the outer portion and the inner portion. The outer portions are fixed to the inner surfaces of places recessed to the rear side of four corners of the front board 17 of the cover 1. The inner portions are fixed to places recessed to the rear side on the front side of four corners of the frame 6. The leaf springs 7 press the frame 6 toward the rear side.

A slider 106 is fixed at the center of the rear surface of the camera module 101. The rear surface of the slider 106 bulges to the rear side as a convex spherical surface. In the XY direction, the center O of the convex spherical surface of the slider 106 coincides with the optical axis and the center of the image sensor 103. Further, in the Z direction, the position of the center O of the convex spherical surface is the approximate center of the camera module 101 including the slider 106, and is the same as the positions of the coil 4 and the magnet 5. By arranging the slider 106 at the center of the rear surface of the housing 105 of the camera module 101, the device can be made thinner. The slider 106 may form the rear surface of the camera module 101 itself in a convex spherical surface shape, or may form the frame 6 so as to have a bottom surface and form the bottom surface in a convex spherical surface shape.

A receiving portion 108 is provided at the center of the front surface of the bottom board 9. The slider 106 and the receiving portion 108 constitute a support mechanism which is arranged between the center of the camera module 101 and the bottom board 9 to tiltably support the camera module 101. The front surface of the receiving portion 108 becomes a concave spherical surface corresponding to the convex spherical surface of the slider 106. In other words, the convex spherical surface and the concave spherical surface have coincident centers O and radii and are in surface contact with each other. The receiving portion 108 is formed to project from the front surface of the bottom board 9 to the front side as a whole, and the rearmost portion of the concave spherical surface is not located closer to the rear side than the bottom board 9 other than the receiving portion 108.

The receiving portion 108 formed separately may be fixed to the front surface of the bottom board 9.

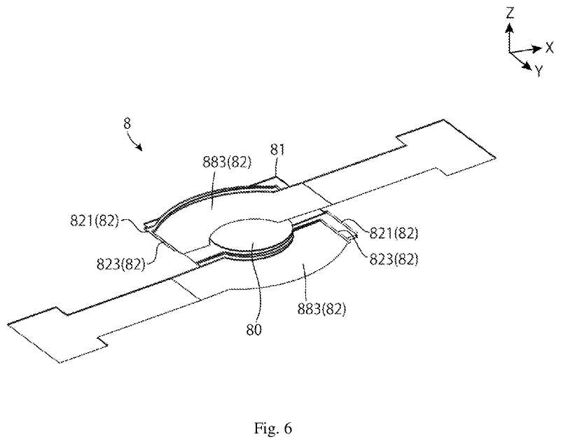

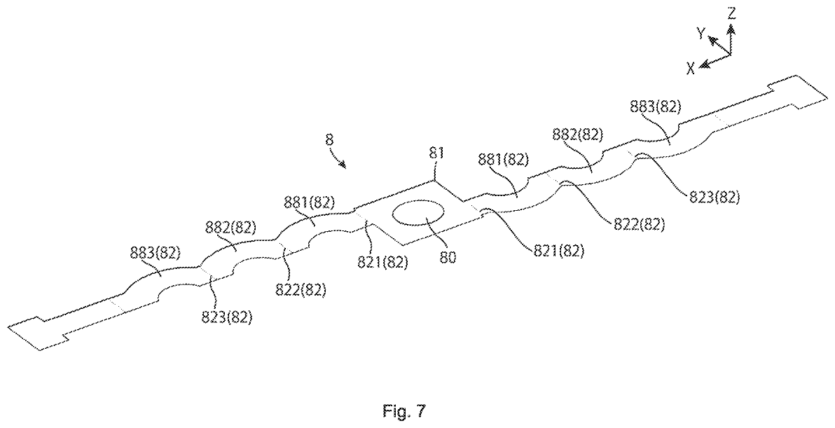

By setting the position of the center O of the slider 106 at the approximate center of the camera module 101 including the slider 106, when the camera module 101 tilted, the moving amounts of the rear end portion and the front end portion of the camera module 101 in the XY direction are approximately equal. The moving amount is almost halved as compared with the case where the tilting center is at the rear end such as the pivot. Further, when it is at the same height as the center O, the moving amount in the XY direction is approximately zero. Since the positions of the magnet 5 and the coil 6 are approximately the same as the position of the center O, the distance between the magnet 5 and the coil 6 is approximately the same even with tilting, so that a stable driving force can be obtained. Further, at this time, the driving force by the magnet 5 and the coil 6 is substantially in the Z direction, the movement of the magnet 5 at the time of tilting is also substantially in the Z direction, and the direction of the driving force and the moving direction are coincident, so that the driving efficiency is also good. In this way, when the driving portion such as the magnet 5 and the coil 6 is arranged so as to generate a driving force in the tangential direction of the circle centered on the center O, the drive efficiency is excellent. A second FPC8 is arranged between the front surface of the bottom board 9 and the rear surface of the camera module 101. As shown in FIG. 6 and FIG. 7, the second FPC8 has a main body portion 81 and two connecting portions 82. The main body portion 81 is square-shaped. A through hole 80 corresponding to the slider 106 is provided at the center of the main body portion 81, and the slider 106 is arranged in this through hole 80. The main body portion 81 is attached to the rear surface of the camera module 101 and is electrically connected to the image sensor 103 and the lens driving device 104 in the camera module 101. The two connecting portions 82 extend so as to be point-symmetrical from two edge portions that are point-symmetrical on the +X side and −X side across the center of the main body portion 81, and are bent multiple times and accommodated in the space between the rear surface of the camera module 101 and the front surface of the bottom board 9. In such a way that the two connecting portions 82 do not overlap, the connecting portion 82 extending from the edge portion on the +X side uses the region on the +Y side from halfway and passes by the slider 106 and the receiving portion 108 on the +Y side, and after being bent multiple times, projects to the outside from the gap between the cover 1 and the bottom board 9 which is formed by the notch of the side board 18 on the −X side. The connecting portion 82 extending from the edge portion on the −X side uses the region on the −Y side from halfway and passes by the slider 106 and the receiving portion 108 on the −Y side, and after being bent multiple times, projects to the outside from the gap between the cover 1 and the bottom board 9 which is formed by the notch of the side board 18 on the +X side.

Two tip end portions of the connecting portion 82 projecting to the +X side and the −X side are electrically connected to an external substrate, respectively. The two connecting portions 82 are fixed to the cover 1 and the bottom board 9 at the positions of the notches.

As shown in FIG. 7, when unfolded, the two connecting portions 82 of the second FPC8 have ridgelines 821 at the base ends connected to the main body portion 81, ridgelines 822 at positions away from the main body portion 81 with respect to the ridgelines 821, and ridgelines 823 at positions away from the main body portion 81 with respect to the ridgelines 822. The two connecting portions 82 are folded at these ridgelines 821, 822, 823 and become bellows shape. The positions of the ridgeline 821, the ridgeline 823 of one folded connecting portion 82 and the position of the ridgeline 822 of the other connecting portion 82 in the X direction are substantially the same, and the positions of the ridgeline 821, the ridgeline 823 of the other connecting portion 82 and the ridgeline 822 of the one connecting portion 82 are substantially the same.

The portions divided by the ridgelines 821, 822, and 823 2 of the two connecting portions 82 have portions bent outward as curved portions 881, 882, and 883. The inner edges of the curved portions 881, 882, and 8832 of the two connecting portions 82 almost overlap when viewed from the Z direction, and surround the slider 106 and the receiving portion 108 from the +Y side and the −Y side.

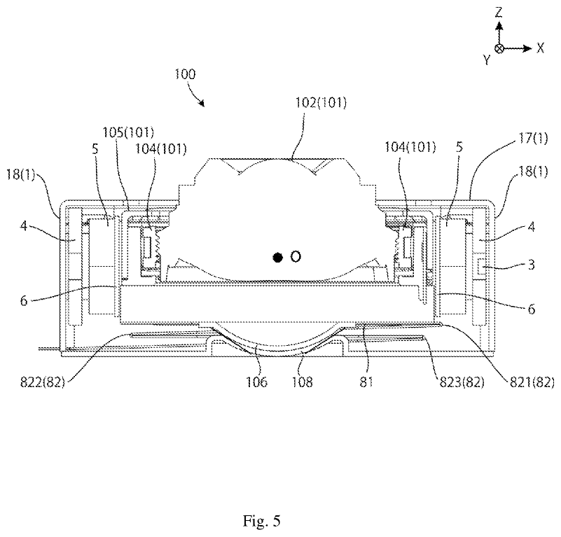

As shown in FIG. 6, the outer edges of the curved portions 881, 882, and 883 of the two connecting portions 82 almost overlap when viewed from the Z direction, and protrude to the outer side farther than the edge portions of the main body portion 81 without protruding beyond the magnets 5 in the Y direction, which is a direction orthogonal to the extending direction of the connecting portion 82. The magnets 5 are located on the outer side farther than the curved portions 881, 882, and 883. As shown in FIG. 5, the rear edges of four magnets 5 on the outer surface of the frame 6 are located closer to the front side than the curved portions 881, 882, and 883. For this reason, even if the camera module 101 tilts, the magnets 5 and the curved portions 881, 882, and 883 will not interfere.

The slider 106 and the receiving portion 108 are located between the inner edges of the curved portions 881, 882, and 883 of the two connecting portions 82. The slider 106 is attached to the rear surface of the camera module 101, and its convex spherical surface is exposed toward the rear side from the through hole 80 of the main body portion 81. The convex spherical surface of the slider 106 is slidably held on the concave spherical surface of the receiving portion 108.

A control portion (not shown) is provided outside the optical member driving device 100. This control portion performs detection control and driving control. In the detection control, the control portion derives the positions of the magnets 5 opposed to the Hall elements 3 on the Z direction based on the output signals of two Hall elements 3, and determines the inclination of the optical axis of the camera module 101, that is, the lens body 102, with respect to the Z axis. In the driving control, the control portion, by supplying current to the coils 4 slides the convex spherical surface of the slider 106 on the concave spherical surface of the receiving portion 108, and causes the camera module 101 to tilt around the X axis and the Y axis. This is done while comparing the required inclination of the optical axis with the actual inclination of the optical axis.

The details of the configuration of the present embodiment have been described above. The optical member driving device 100 according to the present embodiment includes a camera module 101 which is an optical member with a lens body 102; a bottom board 9; a slider 106 which is provided on the rear surface of the camera module 101 and has a convex spherical surface; and a receiving portion 108 which is provided on the front surface of the bottom board 9 and receives the slider 106 at least at three points. By providing the receiving portion 108 receiving the slider 106 with a convex spherical surface at least at three points, the camera module 101 tilts together with the slider 106 around the center of the convex spherical surface of the slider 106. Thus, the tilting center can be set inside the camera module 101, and the moving amount of the front end portion of the camera module 101 can be reduced. Accordingly, it is possible to provide an optical member driving device 100 that can be miniaturized. Further, by arranging the slider 106 in the vicinity of the center of the image sensor 103, the slider 106 can simultaneously perform the sliding of the camera module 101 and the heat dissipation of the image sensor 103.

It is to be noted that, in the embodiment described above, the receiving portion 108 may be provided with three convex portions at positions of the apexes of a triangle containing the optical axis of the lens body 102 inside thereof, and the convex spherical surface of the slider 106 may be slidably supported on the three convex portions of the receiving portion 108. With such a configuration of three-point support, the friction between the convex spherical surface and the receiving portion 108 may be reduced. Further, at least three balls may be rotatably arranged as the receiving portion 108, and the convex spherical surface of the slider 106 may be supported via these balls.

Further, a lubricant may be interposed between the slider 106 and the receiving portion 108. Further, a magnetic body may be arranged on the front surface of the bottom board 9 to exercise an attractive force with the magnet 5. In this case, leaf spring 7 may not be arranged. Further, a coil wound around the Z direction as an axis may be provided between the magnet 5 and the magnetic body. Thereby, the camera module can also be rotated around the Z direction as an axis.

What is claimed is:

1. An optical member driving device, comprising:
an optical member with a lens body;
a bottom board;
a slider provided on a rear surface of the optical member and comprising a convex spherical surface; and
a receiving portion provided on a front surface of the bottom board and receiving the slider at least at three points.

2. The optical member driving device according to claim 1, wherein the receiving portion comprises a concave spherical surface, and the convex spherical surface is slidably held on the concave spherical surface.

3. The optical member driving device according to claim 2, wherein centers and radii of the convex spherical surface and the concave spherical surface are coincident.

4. The optical member driving device according to claim 1, wherein the receiving portion comprises three convex portions, and the convex spherical surface is slidably held on the three convex portions.

5. The optical member driving device according to claim 3, wherein the three convex portion are located at apexes of a triangle containing the optical axis when viewed from an optical axis direction of the lens body.

6. The optical member driving device according to claim 1, further comprising a cover that covers the optical member and is combined with the bottom board, wherein a coil is provided on one of an outer surface of the optical member and an inner surface of the cover, and a magnet opposed to the coil is provided on the other of the outer surface and the inner surface.

7. The optical member driving device according to claim 6, wherein in the optical axis of the lens body, a position of the center of the convex spherical surface is the same as a position of the coil and the magnet.

8. A camera device comprising the optical member driving device according to claim 1.

9. An electronic apparatus comprising the camera device according to claim 8.
